(19) United States
(12) Patent Application Publication
(10) Pub. No.: US 2019/0204464 A1
(43) Pub. Date: Jul. 4, 2019

(54) Method and System for Modeling in a Subsurface Region

(71) Applicants: Paul J. Moore, III, Spring, TX (US); Fermin Fernandez-Ibanez, Spring, TX (US); James M. Degraff, Houston, TX (US)

(72) Inventors: Paul J. Moore, III, Spring, TX (US); Fermin Fernandez-Ibanez, Spring, TX (US); James M. Degraff, Houston, TX (US)

(21) Appl. No.: 16/215,201

(22) Filed: Dec. 10, 2018

Related U.S. Application Data
(60) Provisional application No. 62/611,662, filed on Dec. 29, 2017.

(51) Int. Cl. G01V 1/28

(52) U.S. Cl. CPC G01V 1/282

(57) ABSTRACT

A method and system are described for creating subsurface models that accounts for non-matrix features. The method includes identifying non-matrix attributes and non-matrix effective properties, constructing a subsurface model for a subsurface region and using the subsurface model in simulations and in hydrocarbon operations, such as hydrocarbon exploration, hydrocarbon development, and/or hydrocarbon production.

### CROSS REFERENCE TO RELATED APPLICATION

This application claims the benefit of U.S. Provisional Application Ser. No. 62/611,662, filed Dec. 29, 2017, the disclosure of which is incorporated herein by reference in its entirety.

### FIELD OF THE INVENTION

This disclosure relates generally to the field of hydrocarbon exploration, hydrocarbon development, and hydrocarbon production and, more particularly, to subsurface modeling. Specifically, the disclosure relates to methods and systems for creating subsurface models that account for non-matrix features. The method may include constructing a subsurface model for a subsurface region and using the subsurface model in simulations and in hydrocarbon operations, such as hydrocarbon exploration, hydrocarbon development, and/or hydrocarbon production.

### BACKGROUND

This section is intended to introduce various aspects of the art, which may be associated with exemplary embodiments of the present disclosure. This discussion is believed to assist in providing a framework to facilitate a better understanding of particular aspects of the present invention. Accordingly, it should be understood that this section should be read in this light, and not necessarily as admissions of prior art.

In hydrocarbon exploration, development, and/or production operations, different types of subsurface models may be used to represent subsurface structures, which may include a description of the subsurface structures and material properties for the subsurface region. For example, the subsurface model may comprise one or more of a geomechanical model, a geologic model, or a reservoir model. The subsurface model may represent measured or interpreted data for the subsurface region and may include objects (e.g., horizons, faults, surfaces, volumes, and the like). The subsurface model may also be discretized with a mesh or a grid that includes nodes and forms mesh elements (e.g., voxels or cells) within the model. By way of example, the subsurface model may be created from a structural framework (e.g., organization of objects) and provide defined compartments or sub-volumes. The geologic model may represent measured or interpreted data for the subsurface region, such as seismic data and well log data. The geologic model may be within a physical space or domain and may have material properties, such as rock properties. The reservoir model may be used to simulate flow of fluids within the subsurface region. Accordingly, the reservoir model may use the same mesh and/or mesh elements as other models, or may resample or upscale the mesh and/or mesh elements to lessen the computations for simulating the fluid flow.

The subsurface model may be used in hydrocarbon operations to predict or estimate how the subsurface region should respond to the hydrocarbon operations. By way of example, the subsurface model may be relied upon for drilling operations to understand fluid behavior and volumes for performing the drilling operations. As another example, the subsurface model may be used to predict the production of hydrocarbons and other fluids from the reservoir. Moreover, the subsurface model may be relied upon to understand the pressures and temperatures within the different regions of the wellbore and/or hydrocarbon field, which may be accessed by different types of wells (e.g., producer wells and/or injector wells).

However, conventional approaches that rely upon subsurface models fail to account for non-matrix features, particularly when addressing reservoir flow dynamics. Thus, the subsurface model may not provide understanding for events, such as lost circulation of the drilling fluids, unexplained production behavior that deviates from the predicted subsurface model results, inconsistencies with well tests results, inconsistencies with pressure testing results and unexpected dynamic response that are not predicted by the subsurface model. Accordingly, subsurface model fail to provide insights to problems or properly model certain subsurface behavior.

Accordingly, there remains a need in the industry for methods and systems that are more efficient and may lessen problems associated with characterizing the subsurface properties in a subsurface model for use in hydrocarbon operations. Further, a need remains for efficient approaches to model and simulate non-matrix features in representing the subsurface region. The present techniques provide methods and systems that overcome one or more of the deficiencies discussed above.

### SUMMARY

In one embodiment, a method for enhancing hydrocarbon operations for a subsurface region is described. The method comprising: obtaining subsurface data associated with a subsurface region; performing a process based characterization of non-matrix attributes based on the subsurface data; creating a conceptual framework based on the process based characterization; assigning non-matrix attributes to the conceptual framework; determining non-matrix effective properties based on the assigned non-matric attributes; and outputting the non-matrix effective properties.

In one or more embodiments, various enhancements may be included. The method may include identifying one or more production anomalies associated with the subsurface region; wherein the non-matrix attributes are associated with one or more karst in the subsurface region; wherein the non-matrix attributes are associated with one or more fractures in the subsurface region; updating the process-based characterization with static data; updating the process-based characterization with dynamic data; integrating the process-based characterizations with seismic data associated with the subsurface region; determining two or more non-matrix types, identifying non-matrix types with one of core data and log data associated with the subsurface region, and using the identified non-matrix types to perform the process based characterization of non-matrix attributes; creating a subsurface model associated with a subsurface region, wherein the subsurface model comprises a plurality of cells, and assigning one or more of the non-matrix effective properties to each of the plurality of cells; simulating fluid flow within the subsurface model based on the non-matrix effective properties; causing a well to be drilled based on the one of the outputted non-matrix effective properties, the simulated fluid flow, and any combination thereof; and/or performing a hydrocarbon operation based on the one of the outputted non-matrix effective properties, the simulated fluid flow, and any combination thereof.

In another embodiment, a system for enhancing hydrocarbon operations associated with a subsurface region is described. The system comprising: a processor; an input device in communication with the processor and configured to receive input data associated with a subsurface region; memory in communication with the processor, the memory having a set of instructions. The set of instructions, when executed by the processor, are configured to: obtain subsurface data associated with a subsurface region; perform a process based characterization of non-matrix attributes based on the subsurface data; create a conceptual framework based on the process based characterization; assign non-matrix attributes to the conceptual framework; determine non-matrix effective properties based on the assigned non-matric attributes; and output the non-matrix effective properties.

In one or more embodiments, the system may include various enhancements. The set of instructions, when executed by the processor, may be configured to: identify one or more production anomalies associated with the subsurface region; update the process-based characterization with static data; update the process-based characterization with dynamic data; integrate the process-based characterizations with seismic data associated with the subsurface region; determine two or more non-matrix types, identify non-matrix types with one of core data and log data associated with the subsurface region, and use the identified non-matrix types to perform the process based characterization of non-matrix attributes; create a subsurface model associated with a subsurface region, wherein the subsurface model comprises a plurality of cells; assign one or more of the non-matrix effective properties to each of the plurality of cells; and/or to simulating fluid flow within the subsurface model based on the non-matrix effective properties.

### BRIEF DESCRIPTION OF THE DRAWINGS

The advantages of the present invention are better understood by referring to the following detailed description and the attached drawings.

FIG. 1 is an exemplary flow chart in accordance with an embodiment of the present techniques.

FIG. 2 is an exemplary flow chart of performing observations in accordance with an embodiment of the present techniques.

FIG. 3 is an exemplary flow chart of performing interpretations in accordance with an embodiment of the present techniques.

FIG. 4 is an exemplary diagram of lost circulation cross plot.

FIGS. 5A and 5B are exemplary diagrams of static data and dynamic data for a cave and fracture.

FIG. 6 is a block diagram of a computer system that may be used to perform any of the methods disclosed herein.

### DETAILED DESCRIPTION

In the following detailed description section, the specific embodiments of the present disclosure are described in connection with preferred embodiments. However, to the extent that the following description is specific to a particular embodiment or a particular use of the present disclosure, this is intended to be for exemplary purposes only and simply provides a description of the exemplary embodiments. Accordingly, the disclosure is not limited to the specific embodiments described below, but rather, it includes all alternatives, modifications, and equivalents falling within the true spirit and scope of the appended claims.

Various terms as used herein are defined below. To the extent a term used in a claim is not defined below, it should be given the broadest definition persons in the pertinent art have given that term as reflected in at least one printed publication or issued patent.

The articles “the”, “a”, and “an” are not necessarily limited to mean only one, but rather are inclusive and open ended so as to include, optionally, multiple such elements.

As used herein, the term “hydrocarbons” are generally defined as molecules formed primarily of carbon and hydrogen atoms such as oil and natural gas. Hydrocarbons may also include other elements or compounds, such as, but not limited to, halogens, metallic elements, nitrogen, oxygen, sulfur, hydrogen sulfide (H2S), and carbon dioxide (CO2). Hydrocarbons may be produced from hydrocarbon reservoirs through wells penetrating a hydrocarbon containing formation. Hydrocarbons derived from a hydrocarbon reservoir may include, but are not limited to, petroleum, kerogen, bitumen, pyrobitumen, asphaltenes, tars, oils, natural gas, or combinations thereof. Hydrocarbons may be located within or adjacent to mineral matrices within the earth, termed reservoirs. Matrices may include, but are not limited to, sedimentary rock, sands, silicilytes, carbonates, diatomites, and other porous media.

As used herein, “hydrocarbon exploration” refers to any activity associated with determining the location of hydrocarbons in subsurface regions. Hydrocarbon exploration normally refers to any activity conducted to obtain measurements through acquisition of measured data associated with the subsurface formation and the associated modeling of the data to identify potential locations of hydrocarbon accumulations. Accordingly, hydrocarbon exploration includes acquiring measurement data, modeling of the measurement data to form subsurface models, and determining the likely locations for hydrocarbon reservoirs within the subsurface. The measurement data may include seismic data, gravity data, magnetic data, electromagnetic data, and the like.

As used herein, “hydrocarbon development” refers to any activity associated with planning of extraction and/or access to hydrocarbons in subsurface regions. Hydrocarbon development normally refers to any activity conducted to plan for access to and/or for production of hydrocarbons from the subsurface formation and the associated modeling of the data to identify preferred development approaches and methods. By way of example, hydrocarbon development may include modeling of the subsurface formation and extraction planning for periods of production, determining and planning equipment to be utilized and techniques to be utilized in extracting the hydrocarbons from the subsurface formation, and the like.

As used herein, “hydrocarbon operations” refers to any activity associated with hydrocarbon exploration, hydrocarbon development and/or hydrocarbon production.

As used herein, “hydrocarbon production” refers to any activity associated with extracting hydrocarbons from subsurface location, such as a well or other opening. Hydrocarbon production normally refers to any activity conducted to form the wellbore along with any activity in or on the well after the well is completed. Accordingly, hydrocarbon production or extraction includes not only primary hydrocarbon extraction, but also secondary and tertiary production techniques, such as injection of gas or liquid for increasing drive pressure, mobilizing the hydrocarbon or treating by, for example, chemicals, hydraulic fracturing the wellbore to promote increased flow, well servicing, well logging, and other well and wellbore treatments.

As used herein, “subsurface model” refers to a model of a subsurface region and may include a reservoir model, geomechanical model, and/or a geologic model. The subsurface model may include subsurface data distributed within the model in two-dimensions (2D) (e.g., distributed into a plurality of cells, such as mesh elements or blocks), three-dimensions (3-D) (e.g., distributed into a plurality of voxels), or more dimensions.

As used herein, a “geologic model” is a subsurface model (e.g., a 2D model or a 3-D model) of the subsurface region having static properties and includes objects, such as faults and/or horizons, and properties, such as facies, lithology, porosity, permeability, or the proportion of sand and shale.

As used herein, a “reservoir model” is a subsurface model (e.g., a 2-D model or a 3-D model) of the subsurface that in addition to static properties, such as porosity and permeability, also has dynamic properties that vary over the timescale of resource extraction, such as fluid composition, pressure, and relative permeability.

As used herein, a “geomechanical model” is a model (e.g., a 2-D model or a 3-D model) of the subsurface that contain properties, such as static properties and may model responses to changes in stress, such as mechanical response. The static properties may include properties, such as rock compressibility and Poisson's ratio, while the mechanical response may include compaction, subsidence, surface heaving, faulting, and seismic events, which may be a response to fluid injection and extraction from the subsurface region.

As used herein, “structural framework” or “framework” refer to a subsurface representation formed from objects (e.g., faults, horizons, other surfaces and model boundaries). For example, the framework is a subsurface representation that contains surfaces and polylines. A framework may be formed by surfaces of geologic, engineering, planning, or other technical relevance.

As used herein, “zone”, “region”, “container”, or “compartment” is a defined space, area, or volume contained in the framework or model, which may be bounded by one or more objects or a polygon encompassing an area or volume of interest. The volume may include similar properties.

As used herein, “mesh” or “grid” is a representation of a region of space (e.g., 2-D domain or 3-D domain), which includes nodes that may form mesh elements, such as polygons or polyhedra, disposed within the region (e.g., a volumetric representation). The mesh may represent surfaces, horizons, faults, and/or other objects by a set of nodes, which may include various mesh elements in the form of polygons or polyhedra, disposed within the region. Properties may be assigned to or associated with the mesh elements.

As used herein, “simulate” or “simulation” is the process of performing one or more operations using a subsurface model and any associated properties to create simulation results. For example, a simulation may involve computing a prediction related to the resource extraction based on a reservoir model. A reservoir simulation may involve performing by execution of a reservoir-simulator computer program on a processor, which computes composition, pressure, and/or movement of fluid as a function of time and space for a specified scenario of injection and production wells by solving a set of reservoir fluid flow equations. A geomechanical simulation may involve performing by execution of a geomechanical simulator computer program on a processor, which computes displacement, strain, stress, shear slip, and/or energy release of the rock as a function of time and space in response to fluid extraction and injection.

As used herein, “non-matrix” refers to features that contribute to OOIP and/or flow within a reservoir, which are not captured by the background host rock properties (e.g., the matrix). Such non-matrix features include faults, joints, fractures, sinkholes, vertical shafts and/or pipes, caves, caverns, large dissolution voids, and/or exposure horizons.

In hydrocarbon operations, a subsurface model is created in the physical space or domain to represent the subsurface region. The subsurface model is a computerized representation of a subsurface region based on geophysical and geological observations made on and below the surface of the Earth. The subsurface model may be a numerical equivalent of a reservoir map (e.g., 2-D reservoir map or 3-D reservoir map) complemented by a description of physical quantities in the domain of interest. The subsurface model may include multiple dimensions and is delineated by objects, such as horizons, fractures, and faults. The subsurface model may include a structural framework of objects, such as faults, fractures, and horizons. Within the subsurface models, a grid or mesh may be used to partition the model into different sub-volumes, which may be used in hydrocarbon operations, such as reservoir simulation studies in hydrocarbon exploration, development, and/or production operations, as well as for representing a subsurface model description of a reservoir structure and material properties. The subsurface model may include a mesh or grid of nodes to divide the structural framework and/or subsurface model into mesh elements, which may include cells or blocks in 2-D, or voxels in 3-D, or other suitable mesh elements in other dimensions. Accordingly, the mesh may be configured to form mesh elements that may represent material properties, such as rock and fluid properties, of a reservoir or may be used for numerical discretization of partial differential equations, such as fluid flow or wave propagation.

To enhance the understanding of the subsurface regions represented by the subsurface model, reservoir simulations may be performed. For example, the reservoir simulations may relied upon to determine well locations, well orientations, specific regions that may be used to economically produce hydrocarbons from a subsurface region. Further, the reservoir simulations may be used to enhance hydrocarbon operations associated with that subsurface region, which may include asset acquisition evaluation, selection of drill site and completion zones and/or equipment, and/or stimulation or injection planning.

To further refine subsurface models and/or to enhance the creation of subsurface models, additional measurements or monitoring may be performed to lessen uncertainty in the subsurface model or previously acquired data may be reprocessed to lessen uncertainty in the subsurface model. By way of example, seismic data, resistivity data and/or gravitational data may be used to provide information about the subsurface region, such as non-matrix features. In addition, core samples, well logs and/or well tests may provide additional information about the non-matrix porosity and permeability within the subsurface region. The reprocessing of the previously acquired data may include calculating a cross plot.

As an enhancement, the present techniques create a subsurface model by accounting for the non-matrix attributes. The non-matrix features include fractures and karst, which may include caves, fractures, faults, well developed touching vugs and sinkholes, for example. In contrast, conventional approaches often fail to capture non-matrix features early in process and when they are recognized lack the integration of dynamic data as part of the characterization effort. Indeed, conventional approaches at characterizing non-matrix type features are often limited to fractures. In the present techniques, the development of non-matrix features is utilized to provide additional insights for the subsurface model, which may be based on observations from the reservoir data, analogs and/or modeling. By way of example, the present techniques may recognize karst features, such as caves, whose spatial distributions can be modeled by understanding the hydrologic regimes at the time to cave development. In contrast, early fracture develop results from variation in carbonate platform geometry with spatial distributions that likely vary within the subsurface region compared to caves that developed along hydrologic flow paths.

To account for the non-matrix features, the present techniques may perform certain operations to monitor or observe the subsurface region. For example, the present techniques screen for non-matrix events by first recognizing zones within the borehole associated with lost circulation (i.e., lost circulation zones “LCZs”). In addition to LCZs, other anomalous drilling events, such as bit drops and/or changes in drilling parameters may also indicate potential non-matrix features. Screening may also include identifying subsurface regions that are highlighted using surveillance techniques (e.g., production logging tools (“PLT”), pulsed neutron logs (“PNL”), and/or modular dynamic testing (“MDT”)); identifying subsurface regions that are associated with unexplained production behavior; identifying subsurface regions that are associated with dynamic response not predicted by an associated subsurface model; and/or identifying subsurface regions that are associated with dynamic inconsistencies from well tests and/or pressure data. By way of example, the screening may include identifying all of the LCZs within a given well and then classify whether it is a fracture of karst feature depending on its dynamic response to the losses. For example, LCZs with high maximum loss rate and low total lost volume are typically karst features, which have capacity for excessive losses that are controlled quickly by the driller, which results in a small amount of total lost volume. Conversely, fractures often have lower values for maximum loss rate with total lost volume that can be substantially high due to drillers often being able to control the low loss rate without adding any proppant, which ultimately leads to a larger total lost volume. This initial screening from the daily drilling reports to identify LCZs becomes the benchmark that may be used to make the additional observations (e.g., PLT responses may align with LCZ intervals and wells with LCZs may have anomalously high permeability thickness (KH) values determined from pressure buildup data).

Following identification of LCZs, the present techniques identifies non-matrix types responsible for the losses features, including, but not limited to, features, such as fractures, caverns, vugs, and/or solution-enhanced fractures.

Following screening for non-matrix types, the present techniques may integrate core and image logs to further refine the classification of non-matrix types. This integration may include calibrating electric responses and the non-matrix types, identifying or determining false positives and artifacts; identifying or determining electric signatures and dynamic potentials (e.g., early PLT integration); and/or calibrating the size of the non-matrix attributes (e.g., fracture width, vug size, and/or cavern height).

In addition, the present techniques may perform process-based characterization for non-matrix classification based on the early utilization of both static and dynamic data sets (e.g., daily drilling reports, core, image logs, PLTs, well tests, and seismic). The process based characterization may include determining non-matrix generations, which may include determining or modeling relative timing and undelaying depositional, mechanical, or hydrological processes (e.g., early versus late, meteoric versus burial, synde-positional versus tectonic) that guide interpretation away from well control. The non-matrix attributes may be interpreted and classified using rules developed from the process-based understanding of the non-matrix feature types, which are considered non-matrix objects that assign specific features types to a set of defining metrics, orientations, spatial arrangement, and relative intensity based on the non-matrix attributes. Also, the process based characterization may include defining zones with dynamic potential using the screening and include production data, such as PLTs and pressure build-ups.

The present techniques may also integrate the non-matrix objects (e.g., the process based characterization) with seismic data. The integration of non-matrix objects with seismic may include identifying and determining objects, such as geobodies (e.g., connected voxels of low seismic impedance) and/or seismic faults that may capture large scale non-matrix structures. For example, core analysis and integrating with well results, including available dynamic data, stratigraphic position, karst analogs and knowledge of karst processes, geologically-valid geobodies can be determined. Geobodies that related to seismic noise, geophysical artifacts and/or lithostratigraphy, may be filtered out through editing, such as manual editing. The result is a distribution of seismically-derived karst geobodies that from a modeling perspective can be imported as deterministic objects into a geologic model workflow.

To further incorporate the observed non-matrix objects, the present techniques may perform certain operations to interpret the subsurface region. The interpretation may include developing a process-based conceptual framework that accounts for both the non-matrix features and attributes. The model may include grids that form cells or may be a gridless. The conceptual model may include determining and defining distribution maps of non-matrix feature types based on the respective genetic origin that provides rules and guidelines to define trends and distributions of the non-matrix attributes (e.g., geometry) across the subsurface region. Also, the conceptual framework and/or model may maintain consistency between processes, timing of the non-matrix objects and burial history of the subsurface region. Such conceptual models may be inputs to, or developed directly within, a 2-D or 3-D geologic model that may include such features.

Then, the non-matrix effective properties may be derived from the assigned non-matrix objects. The derivation of the non-matrix effective properties may involve calibrating non-matrix objects to dynamic data to derive effective properties (e.g., porosity and permeability) from estimations of permeability based on, but not limited to, (1) loss rate within LCZs, (2) spinner/inflow rates from PLTs, (3) derivations of permeability thickness (“Kh”) from pressure build up data, and/or (4) analogs including surface and subsurface data sets. The derivation of the non-matrix effective properties may be reiterated with the assigning non-matrix class where sufficient subsurface production data is available. The reiteration may involve adjusting non-matrix objects and re-deriving non-matrix effective properties and/or to adjusting the non-matrix effective properties and re-deriving non-matrix effective properties based on the adjustments.

Once the non-matrix effective properties are derived, subsurface modeling may be performed. The subsurface modeling may include creating a subsurface model that represents the subsurface region, assigning the non-matrix effective properties within the subsurface model; initializing the subsurface model for a simulation, performing a simulation (e.g., for various time steps); and/or outputting the results of the simulation, which may be stored in memory and/or displayed. Optionally, the subsurface modeling may include calculating an objective function result from an objective function, adjusting the properties in the subsurface model and re-performing the simulation until the objective function result is below a threshold. In addition, subsurface modeling may include performing a sensitivity analysis based on expected performance at either/or individual wells, within a defined sector or region of the subsurface region, or field-wide that includes the entire subsurface region.

Once the modeling is complete, the hydrocarbon operations may be performed based on the simulation results. The hydrocarbon operations may include reservoir management, wellbore performance forecasting, and/or field development strategies, which may involve determining the placement of one or more wells and/or determining a completion strategy for each of the respective wells. In addition, the hydrocarbon operations may include determining production feasibility and/or determining performance forecasts.

Accordingly, the present techniques may enhance the generation of subsurface models. For example, in one or more configurations, a method for enhancing hydrocarbon operations for a subsurface region is described. The method comprising: obtaining subsurface data associated with a subsurface region; performing a process based characterization of non-matrix attributes based on the subsurface data; creating a conceptual framework based on the process based characterization; assigning non-matrix attributes to the conceptual framework; determining non-matrix effective properties based on the assigned non-matric attributes; and outputting the non-matrix effective properties.

In one or more configurations, the method may include various enhancements.

The method may include identifying one or more production anomalies associated with the subsurface region; wherein the non-matrix attributes are associated with one or more karst in the subsurface region; wherein the non-matrix attributes are associated with one or more fractures in the subsurface region; updating the process-based characterization with static data; updating the process-based characterization with dynamic data; integrating the process-based characterizations with seismic data associated with the subsurface region; determining two or more non-matrix types, identifying non-matrix types with one of core data and log data associated with the subsurface region, and using the identified non-matrix types to perform the process based characterization of non-matrix attributes; creating a subsurface model associated with a subsurface region, wherein the subsurface model comprises a plurality of cells, and assigning one or more of the non-matrix effective properties to each of the plurality of cells; simulating fluid flow within the subsurface model based on the non-matrix effective properties; causing a well to be drilled based on the one of the outputted non-matrix effective properties, the simulated fluid flow, and any combination thereof and/or performing a hydrocarbon operation based on the one of the outputted non-matrix effective properties, the simulated fluid flow, and any combination thereof.

In another configuration, a system for enhancing hydrocarbon operations associated with a subsurface region is described. The system comprising: a processor; an input device in communication with the processor and configured to receive input data associated with a subsurface region; memory in communication with the processor, the memory having a set of instructions. The set of instructions, when executed by the processor, are configured to: obtain subsurface data associated with a subsurface region; perform a process based characterization of non-matrix attributes based on the subsurface data; create a conceptual framework based on the process based characterization; assign non-matrix attributes to the conceptual framework; determine non-matrix effective properties based on the assigned non-matric attributes; and output the non-matrix effective properties.

In one or more configurations, the system may include various enhancements.

The set of instructions, when executed by the processor, may be configured to: identify one or more production anomalies associated with the subsurface region; update the process-based characterization with static data; update the process-based characterization with dynamic data; integrate the process-based characterizations with seismic data associated with the subsurface region; determine two or more non-matrix types, identify non-matrix types with one of core data and log data associated with the subsurface region, and use the identified non-matrix types to perform the process based characterization of non-matrix attributes; create a subsurface model associated with a subsurface region, wherein the subsurface model comprises a plurality of cells; assign one or more of the non-matrix effective properties to each of the plurality of cells; and/or to simulating fluid flow within the subsurface model based on the non-matrix effective properties.

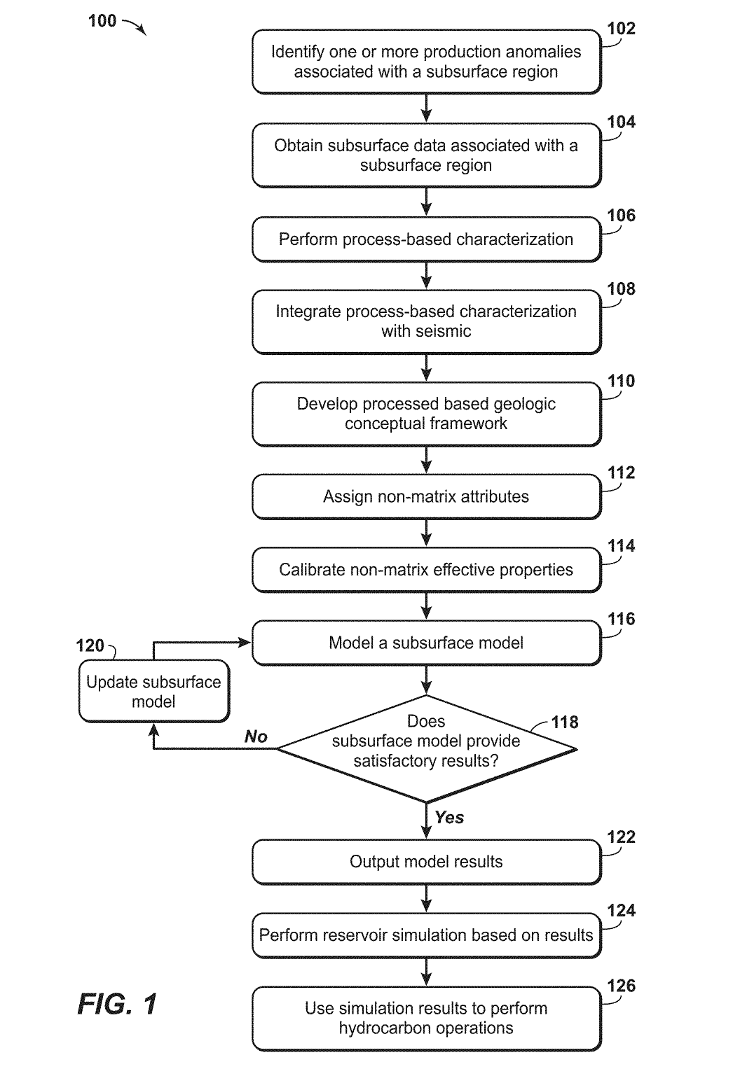

Beneficially, the present techniques provide various enhancement for the creation and use of subsurface models, such as recognizing potential drilling hazards and completion strategies where non-matrix features are present, accounting for additional hydrocarbon pore volumes that can be overlooked/not accounted for when only using pore volumes determined from evaluations of the matrix properties, and/or understanding variations in lateral and vertical permeability and anisotropy due non-matrix features. The present techniques may be further understood with reference to the FIGS. 1 to 6 below.

FIG. 1 is an exemplary flow chart 100 in accordance with an embodiment of the present techniques. The flow chart 100 includes a method for creating subsurface models that accounts for non-matrix attributes. The method may include obtaining subsurface measurements, performing observations associated with the non-matrix attributes, constructing a subsurface model for the subsurface region and using the subsurface model in simulations and in hydrocarbon operations, such as hydrocarbon exploration, hydrocarbon development, and/or hydrocarbon production. The method may include obtaining subsurface measurements and performing observations associated with the non-matrix attributes for a subsurface region, as shown in blocks 102 to 108. Then, the interpretations are performed to create a subsurface model that accounts for non-matrix attributes, which is simulated and the results are used to perform simulations and for hydrocarbon operations, as shown in blocks 110 to 126.

To begin, the method may include performing obtaining subsurface measurements and performing observations associated with the non-matrix attributes for a subsurface region, as shown in blocks 102 to 108. At block 102, one or more production anomalous associated with a subsurface region are identified. The identification of the production anomalies may include identifying subsurface regions that are associated with lost circulation and/or other anomalous drilling events, where instantaneous losses of drilling material escape into the subsurface; identifying subsurface regions that are associated with surveillance issues, such as rapid changes in PLT spinner data; identifying subsurface regions that are associated with unexplained production behavior; identifying subsurface regions that are associated with dynamic response not predicted by an associated subsurface model; and/or identifying subsurface regions that are associated with dynamic inconsistencies from well tests and/or pressure build up data. By way of example, the screening may include evaluating drilling reports and determining variations in the drilling reports to identify locations. At block 104, subsurface data associated with a subsurface region is obtained. The obtaining of subsurface data may include accessing previously acquired subsurface data and/or performing one or more operations to obtain measurements associated with the subsurface regions. The subsurface data may include daily drilling reports, real-time drilling data, core samples, wireline and image logs, and surveillance data, such as PNLs and MDTs. Then, at block 106, process-based characterization is performed. The process-based characterization may involve classifying the types of non-matrix features based on the geologic, mechanical, and hydrologic processes responsible for their development. Such understanding of each feature class/type allows rules to be developed to guide building a conceptual framework away from well control.

By performing a process-based characterization, each feature class and/or type can be assigned metrics, orientations, spatial arrangement, and relative intensity of the non-matrix attributes both at or near the wellbore and in between well control. For example, early fractures often form along platform margins due to gravitational instability along steep walls of the platform. Such fractures may exhibit different distribution parameters and effective properties compared to fractures that form during burial under influences of stress regimes and variations of mechanical properties of the reservoir host rock. At block 108, process-based characterization is integrated with seismic data. The integration may include geobodies that reflect karst caves and/or fault planes that facilitate interpretation between wellbore control, although limited to features that can be detected in seismic.

Once the performing observations involving the non-matrix attributes are completed, the interpretations are performed to create a subsurface model that accounts for non-matrix attributes, which is simulated and the results are used to perform simulations and for hydrocarbon operations, as shown in blocks 110 to 126. At block 110, a processed based geologic conceptual framework is developed. The development of the conceptual model may include determining and defining process-based distribution maps of non-matrix feature types based on the respective genetic origin. By way of example, the development may include karst caves that develop along paleoshorelines within freshwater lens (see e.g., Myloire et al. (1990), “The flank margin model for dissolution cave development in carbonate platforms”, Earth Surface Processes and Landforms, Vol. 15, pp. 413-424) versus caves that form due to rivers sinking and flow underground (see e.g., Palmer (1991), “Origin and morphology of limestone caves”, Geological Society of America Bulletin, Vol. 103, pp. 1-21). At block 112, non-matrix attributes are assigned based on classification of the non-matrix feature types in the process-based framework. For example, if a subsurface region has karst caves that formed along paleoshorelines, analog surface data indicates that multiple, isolated caves may extend along the shoreline with each cave have a maximum inland dimension (e.g., perpendicular to the shoreline) of about 200 meters (m) By way of example, the method may use the method in Labourdette et al. (2007), “Process-like modeling of flank-margin caves: from genesis to burial evolution”, Journal of Sedimentary Research, Vol. 77, pp. 965-979. Then, at block 114, the non-matrix effective properties may be calibrated from the assigned non-matrix attributes. The calibration of the non-matrix effective properties may involve using dynamic data to derive effective properties (e.g., porosity and permeability). The calibration may involve conditioning features identified in image logs or other static data sets, such as wireline or core, to dynamic data sets, such as LCZs during drilling, discrete intervals within PLT runs, and/or calculations of Kh from pressure build up data.

At block 116, the subsurface model is modeled. The modeling of the subsurface model may include creating a subsurface model to represent the subsurface region; assigning the non-matrix effective properties to the subsurface model. In addition, the modeling the subsurface model may include performing a simulation with the subsurface model using the assigned non-matrix effective properties, performing calculations with the non-matrix effective properties in the subsurface model and/or performing a forward modeling with the with the non-matrix effective properties in the subsurface model. The subsurface model may be created based on measurement data or accessed from memory. The measurement data may include seismic data, resistivity data, gravity data, well log data, core sample data, and combinations thereof. The subsurface model may include geologic features, such as horizons and faults. By way of example, the creation of the subsurface model may include forming a structural framework of objects (e.g., surfaces, such as faults, horizons, and if necessary, additional surfaces that bound the area of interest for the model), verifying or forming the objects into closed volumes, meshing or partitioning the volume into sub-volumes (e.g., cells, mesh elements or voxels) defined by a mesh (e.g., a three dimensional (3-D) mesh or 3-D grid), and assigning properties to the mesh elements. The properties may include porosity and/or permeability, which include the non-matrix effective properties. At block 118, a determination is made whether the subsurface model provides satisfactory results. The satisfactory results may include computing the value of an objective function and determining whether the value of the objective function is below a threshold value. If the subsurface model does not provide satisfactory results, the subsurface model may be updated, as shown in block 120. The updating of the subsurface model may include adjusting the properties in the subsurface model and/or updating the framework or structure in the subsurface model. Then, the updates to the subsurface model may be provided to perform additional modeling of the subsurface model, as shown in block 116. If the subsurface model does not provide satisfactory results, the subsurface model may be output, as shown in block 122. The outputting of the subsurface model may include displaying and/or storing the subsurface model and associated properties.

At block 124, the reservoir simulation is performed based on the outputted model results. The performance of the simulation may include performing the calculations and/or modeling fluid flow. The performance of the simulation may include modeling the fluid flow for various time steps. The simulation results may be output by displaying the simulation results on a monitor and/or storing the simulation results in memory of a computer system. Performing the simulation may include modeling fluid flow based on the subsurface model and the associated properties stored within the cells of the subsurface model. The simulation results may include the computation of time-varying fluid pressure and fluid compositions (e.g., oil, water, and gas saturation) and the prediction of fluid volumes produced or injected at wells. Performing the simulation may also include modeling fluid and/or structural changes based on the subsurface model and the associated properties stored within the mesh elements of the subsurface model. The simulation results may be output by displaying the simulation results on a monitor and/or storing the simulation results in memory of a computer system.

Then, the simulation results are for hydrocarbon operations, as shown in blocks 126. The output simulation results may be used for drilling exploration or development wells and may also be used for reservoir simulation in production phase. The hydrocarbon operations may include hydrocarbon exploration operations, hydrocarbon development operations, and/or hydrocarbon production operations. For example, the simulation results and/or the subsurface model may be used to estimate or adjust reserves forecasts, reserves estimations, and/or well performance prediction. As another example, the simulation results and/or the subsurface model may be used to adjust hydrocarbon production operations, such as installing or modifying a well or completion, modifying or adjusting drilling operations and/or installing or modifying a production facility. Further, the results may be utilized to predict hydrocarbon accumulation within the subsurface region; to provide an estimated recovery factor; and/or to determine rates of fluid flow for a subsurface region. The production facility may include one or more units to process and manage the flow of production fluids, such as hydrocarbons and/or water, from the formation.

Beneficially, this method provides an enhancement in the production, development, and/or exploration of hydrocarbons. In particular, the method may be utilized to enhance development of subsurface models that properly characterize and account for non-matrix attributes. Further, the results may provide an enhanced subsurface model with less computational effort, less interactive intervention, and/or in a computationally efficient manner. As a result, this may provide enhancements to production at lower costs and lower risk.

As may be appreciated, the blocks of FIG. 1 may be omitted, repeated, performed in a different order, or augmented with additional steps not shown. Some steps may be performed sequentially, while others may be executed simultaneously or concurrently in parallel.

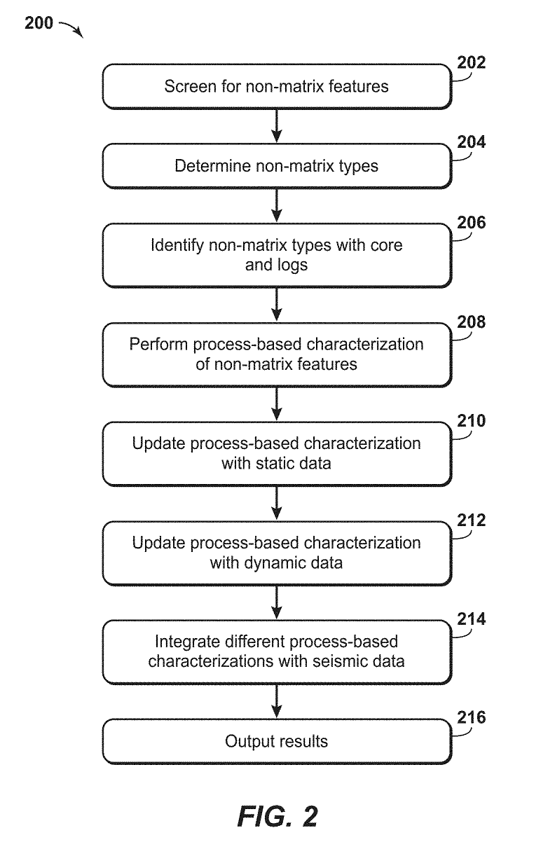

As noted in FIG. 1, the obtaining subsurface measurements and performing observations associated with the non-matrix attributes for a subsurface region are shown in blocks 102 to 108. An exemplary method of performing these steps is described in FIG. 2. FIG. 2 is an exemplary flow chart 200 of performing observations in accordance with an embodiment of the present techniques. This method may involve performing various calculations to obtain subsurface measurements and to perform observations associated with the non-matrix attributes.

To begin, the method may include screening for non-matrix features, as shown in block 202. This screening may be performed in a similar manner to block 102 in FIG. 1. At block 204, non-matrix types are determined. The determination of the non-matrix types may include initial classification from LCZs as either a fracture-dominated feature or a karst-dominated feature utilizing daily drilling reports and real-time drilling data. Following initial screening of LCZs, the non-matrix types is identified with core and logs, as shown in block 206. The additional data including, but not limited to, core and wireline logs are used to further refine the type of non-matrix feature responsible for the LCZ. The identification may include different generations of fractures, faults, and/or karst features including vugs, solution pipes, and caves. Then, at block 208, a process-based characterization of non-matrix features is performed. The process-based characterization may assigns a genetic process to each feature observed. The process-based characterization provides insight on the geologic, mechanical, and/or hydrologic controls responsible for development, and, as such, provides an understanding of the magnitude and distribution of each feature. By combining the observations of the non-matrix feature with the process(es) responsible for its development, such understanding allows the interpreter to generate a set of rules for each feature that account for the location, size, geometry, distribution, relative spacing, and spatial density of each feature. The process-based characterization are updated with static data, as shown in block 210. These components are collectively referred to as the attributes of the non-matrix feature that may become the non-matrix objects (feature with defined attributes). At block 212, the process-based characterization may be updated with dynamic data. The updating may be based on where and when available, the non-matrix objects are conditioned with dynamic data to include a level of characterization often overlooked during static data integration. At this step, integration of dynamic data provides further insight on the characterization of the non-matrix features by ranking certain features over others. For example, if observations from a well indicate that five non-matrix features are present but only two of the non-matrix features experienced losses during drilling, the observation that these features allowed drill fluids to escape into the reservoir suggest that they should possess properties in excess of those features that did not contribute to losses during drilling. At block 214, different process-based characterizations are integrated with seismic data. This integration may include derivations of seismic data, such as geobodies and/or faults. Then, at block 216, the results are outputted. The output of the results may include one or more of effective properties and/or subsurface model that accounts for non-matrix data. The output results may be stored in memory and/or displayed on a monitor.

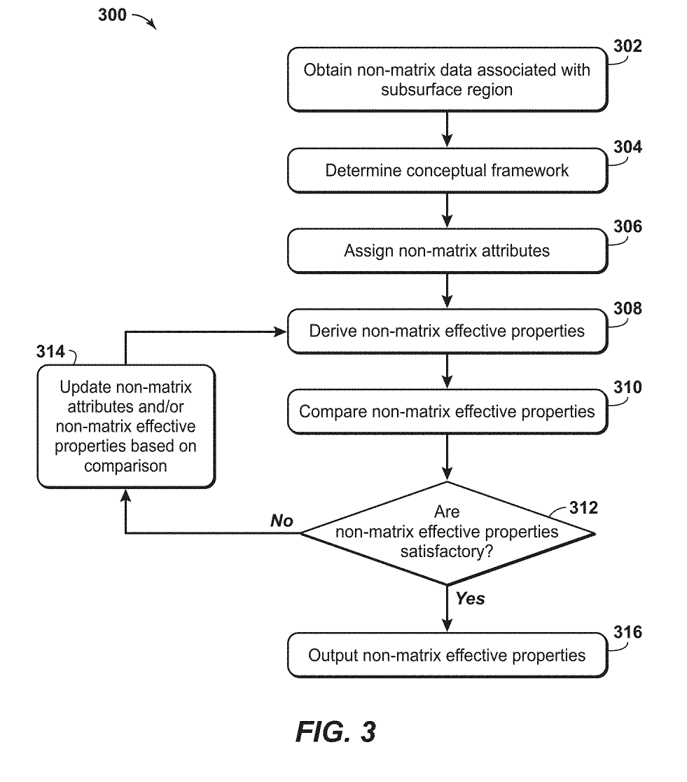

Further, as noted in FIG. 1, the non-matrix attributes are determined and used to determine non-matrix effective properties are shown in blocks 110 to 114. An exemplary method of performing these steps is described in FIG. 3. By way of example, FIG. 3 is an exemplary flow chart 300 of performing interpretations in accordance with an embodiment of the present techniques. This method may involve performing various calculations to obtain non-matrix effective properties from the conceptual framework and non-matrix objects.

To begin, the method may include obtaining non-matrix data associated with subsurface region, as shown in block 302. The non-matrix data may include fractures, faults, vugs, solution pipes, and/or caves. At block 304, a process-based conceptual model is determined in the form of either a set or sets of schematic 2D or 3D drawing(s) in either cross-section or map view that resides on paper or stored on memory and/or displayed on a monitor. The determination of the conceptual model may be performed in similar manner to block 110 of FIG. 1. The non-matrix attributes are assigned, as shown in block 306. The conceptual model, which may be a 2-D or 3-D representation, may include attributes, such as type, location, size, geometry, relative position, spatial distribution, and density of the non-matrix feature. Then, at block 308, the non-matrix effective properties are derived. The derivation of effective properties may be based on calculations from reservoir data sets including, but not limited to, drilling parameters, LCZs, PLTs, well tests and pressure build up data, and analog data. The derivation of non-matrix effective properties may include estimates of porosity and permeability based on loss rates within LCZs, flow rates calculated during PLT runs, and/or analog data. At block 310, the non-matrix effective properties are compared. The comparison may be with expected results based on real-world examples from similar analog reservoirs or surface outcrop data. The comparison of the non-matrix effective properties may include comparison of production index from wells in similar reservoirs with comparable non-matrix features or expectations based on dynamic behavior within analogs including water aquifers. Then, a determination is made whether the non-matrix effective properties are satisfactory, as shown in block 312. The determination whether the non-matrix effective properties is satisfactory may include matching modeled well performance with well test data. If non-matrix effective properties are not satisfactory, the non-matrix attributes and/or non-matrix effective properties are updated based on comparison, as shown in block 314. The updating of the non-matrix attributes and/or non-matrix effective properties may include modifying non-matrix attributes and properties to account for issues coming in simulation scenarios, such as upscaling. Then, the updated attributes or properties may be used to derive the non-matrix effective properties, as shown in block 308. If non-matrix effective properties are satisfactory, the non-matrix effective properties are outputted, as shown in block 316. The output of the non-matrix effective properties may include storing the non-matrix effective properties in memory and/or displaying the non-matrix effective properties on a monitor.

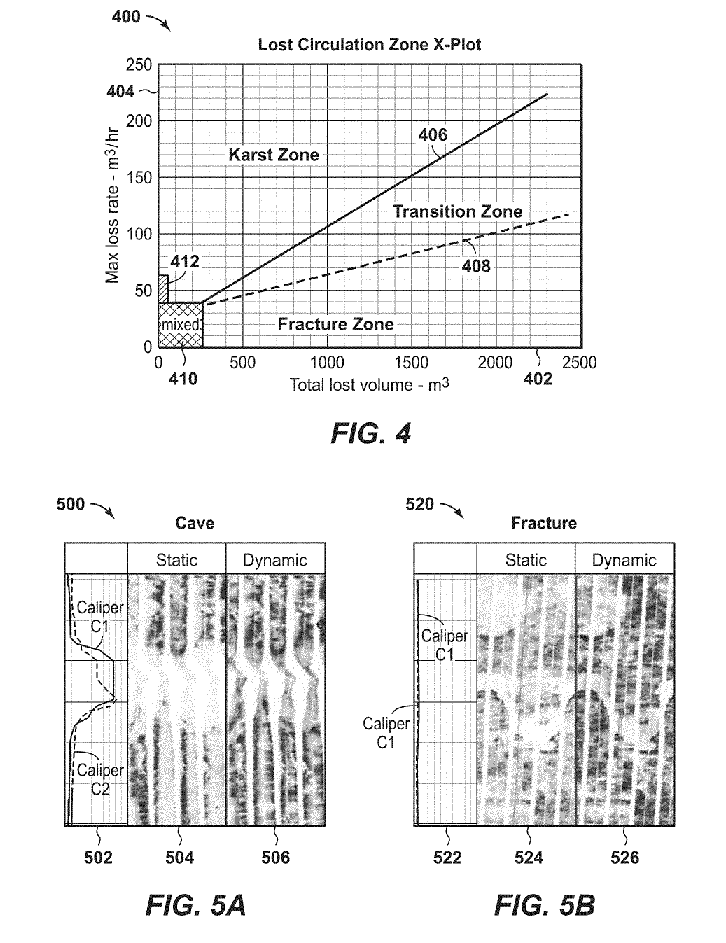

FIG. 4 is an exemplary diagram 400 of lost circulation cross plot. In this diagram 400, the various zones are shown for a subsurface region as compared with a maximum loss rate axis 404 in cubic meters per hour (m³/hr) versus the total lost volume axis 402 in cubic meters (m³). In this diagram 400, the solid line 406 and the dashed line 408 divide the chart into different zones that reflect qualitative divisions of maximum loss rate versus total lost volume based on the amount of drilling material and the rate at which a non-matrix feature can contribute to a fluid loss. The karst zone is shown as the region between axis 404 and solid line 406 and outside of the mixed zone 410 and the zone 412. The transition zone is shown as the region between solid line 406 and the dashed line 408 and outside of the mixed zone 410. The fracture zone is shown as the region between axis 402 and dashed line 408 and outside of the mixed zone 410. These divisions provide a mechanism to identify all of the LCZs within a given well and then classify whether it is a fracture or karst feature depending on its dynamic response to the losses. For example, LCZs with high maximum loss rate (e.g., values on the y-axis) and low total lost volume (e.g., values on the x-axis) are typically karst features, which have capacity for excessive losses that are controlled quickly by the driller. Hence the small amount of total lost volume. Conversely, fractures often have lower values for maximum loss rate with total lost volume that can be substantially high due to drillers often being able to control the low loss rate without adding any proppant, which ultimately leads to a larger total lost volume.

FIGS. 5A and 5B are exemplary diagrams 500 and 520 of image log response for a cave and fracture, showing both static and dynamic normalization. Image logs represent variations in resistivity and conductivity along the borehole wall. Static images are generated by displaying the resistivity/conductivity contrast through a normalized histogram that assigns one end of the color spectrum to the most resistive features found along the entire wellbore wall and the other end of the color spectrum to the most conductive features. Conversely, dynamic images are generated by displaying the resistivity and/or conductivity contrast utilizing a re-normalization through a sliding window of typically 1 meter (m) to 2 m to enhance local contrasts along the borehole wall. In FIG. 5A, an exemplary diagram 500 of a cave is shown for various caliper responses in block 502, static data responses in block 504 and dynamic data responses in block 506. In FIG. 5B, an exemplary diagram 520 of a fracture is shown for various caliper responses in block 522, static data responses in block 524, and dynamic data responses in block 526.

Persons skilled in the technical field will readily recognize that in practical applications of the disclosed methodology, it is partially performed on a computer, typically a suitably programmed digital computer. Further, some portions of the detailed descriptions which follow are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following to discussions, it is appreciated that throughout the present application, discussions utilizing the terms such as “processing” or “computing”, “calculating”, “comparing”, “determining”, “displaying”, “copying,” “producing,” “storing,” “adding,” “applying,” “executing,” “maintaining,” “updating,” “creating,” “constructing” “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Embodiments of the present techniques also relate to an apparatus for performing the operations herein. This apparatus may be specially constructed for the required purposes, or it may comprise a general-purpose computer selectively activated or reconfigured by a computer program stored in the computer (e.g., one or more sets of instructions). Such a computer program may be stored in a computer readable medium. A computer-readable medium includes any mechanism for storing or transmitting information in a form readable by a machine (e.g., a computer). For example, but not limited to, a computer-readable (e.g., machine-readable) medium includes a machine (e.g., a computer) readable storage medium (e.g., read only memory (“ROM”), random access memory (“RAM”), magnetic disk storage media, optical storage media, flash memory devices, etc.), and a machine (e.g., computer) readable transmission medium (electrical, optical, acoustical or other form of propagated signals (e.g., carrier waves, infrared signals, digital signals, etc.)).

Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present techniques are in no way limited to implementation in any specific operating system or environment.

By way of example, a simplified representation for subsurface structures is utilized to create subsurface models, which may be used in hydrocarbon operations. Thus, the present techniques may be used to enhance construction of subsurface models, which may be used for hydrocarbon operations and, more particularly, to subsurface modeling. For a subsurface model, a structural and geologic framework is created from subsurface measurements. The modeled framework may include various objects, such as faults, faults, stratigraphic horizons, karst features including, but not limited to, vugs, caves, solution pipes, and if necessary, one or more surfaces that bound the area of interest. The different objects are meshed to define closed volumes (e.g., zones, compartments, or subvolumes). Then, the closed volumes may be partitioned into small cells defined by the grid. Finally, properties are assigned to cells or objects (e.g., surface transmissibility) and individual cells (e.g., rock type and/or porosity) in the structural framework to form the subsurface model. The subsurface model may be upscaled to perform a simulation.

The present techniques may be utilized to enhance the creation of a subsurface model. The subsurface model, which may include a reservoir model, geomechanical model and/or geologic model, is a computerized representation of a subsurface region based on geophysical and geological observations associated with at least a portion of the specified subsurface region. In particular, the subsurface model may account for non-matrix attributes, as noted above. Subsurface models, such as reservoir models, may be used as input data for reservoir simulators or reservoir simulation programs that compute predictions for the behavior of rocks and fluids contained within a subsurface region under various scenarios of hydrocarbon recovery. Using subsurface models in simulations provides a mechanism to identify which recovery options offer the most efficient, and effective development plans for a subsurface region (e.g., a particular reservoir and/or field). Accordingly, accounting for non-matrix attributes may enhance the simulations.

Construction of a subsurface model for a fluid flow simulation is typically a multistep process. Initially, a structural model or structural framework is created from objects (e.g., surfaces, such as faults, horizons, and if necessary, additional surfaces that bound the area of interest for the model). The object may be adjusted or include non-matrix attributes. The different objects define closed volumes, which may be referred to as zones, subvolumes, compartments and/or containers. Then, each zone is meshed or partitioned into sub-volumes (e.g., cells, mesh elements or voxels) defined by a mesh (e.g., a 3-D mesh or 3-D grid). Once the partitioning is performed, properties are assigned to objects (e.g., transmissibility) and individual sub-volumes (e.g., rock type, porosity, permeability, rock compressibility, or oil saturation). The objects (e.g., surfaces) are represented as meshes, while the mesh elements form a mesh. Then, the assignment of properties is often also a multistep process where mesh elements are assigned properties. The properties may be assigned in the creation of the subsurface model. For example, properties may include porosity and permeability, which may be based on the non-matrix attributes determined by the present techniques. Accordingly, the method may include performing the various calculations, as noted above in associated discuss and flow charts.

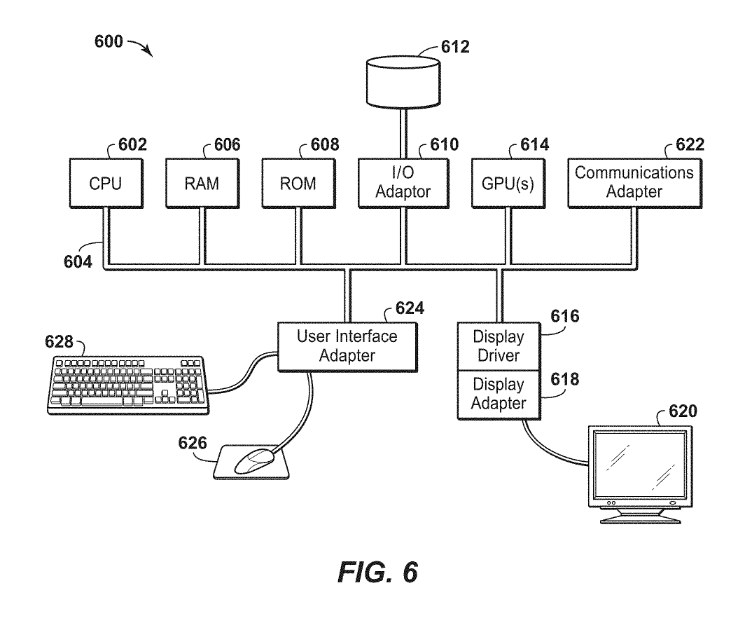

Further, one or more embodiments may include methods that are performed by executing one or more sets of instructions to perform modeling enhancements in various stages. For example, FIG. 6 is a block diagram of a computer system 600 that may be used to perform any of the methods disclosed herein. A central processing unit (CPU) 602 is coupled to system bus 604. The CPU 602 may be any general-purpose CPU, although other types of architectures of CPU 602 (or other components of exemplary system 600) may be used as long as CPU 602 (and other components of system 600) supports the inventive operations as described herein. The CPU 602 may execute the various logical instructions according to disclosed aspects and methodologies. For example, the CPU 602 may execute machine-level instructions for performing processing according to aspects and methodologies disclosed herein.

The computer system 600 may also include computer components such as a random access memory (RAM) 606, which may be SRAM, DRAM, SDRAM, or the like.

The computer system 600 may also include read-only memory (ROM) 608, which may be PROM, EPROM, EEPROM, or the like. RAM 606 and ROM 608 hold user and system data and programs, as is known in the art. The computer system 600 may also include an input/output (I/O) adapter 610, a graphical processing unit (GPU) 614, a communications adapter 622, a user interface adapter 624, and a display adapter 618. The I/O adapter 610, the user interface adapter 624, and/or communications adapter 622 may, in certain aspects and techniques, enable a user to interact with computer system 600 to input information.

The I/O adapter 610 preferably connects a storage device(s) 612, such as one or more of hard drive, compact disc (CD) drive, floppy disk drive, tape drive, etc. to computer system 600. The storage device(s) may be used when RAM 606 is insufficient for the memory requirements associated with storing data for operations of embodiments of the present techniques. The data storage of the computer system 600 may be used for storing information and/or other data used or generated as disclosed herein. The communications adapter 622 may couple the computer system 600 to a network (not shown), which may enable information to be input to and/or output from system 600 via the network (for example, a wide-area network, a local-area network, a wireless network, any combination of the foregoing). User interface adapter 624 couples user input devices, such as a keyboard 628, a pointing device 626, and the like, to computer system 600. The display adapter 618 is driven by the CPU 602 to control, through a display driver 616, the display on a display device 620. The subsurface model, simulation results and/or scanning curves may be displayed, according to disclosed aspects and methodologies.

The architecture of system 600 may be varied as desired. For example, any suitable processor-based device may be used, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may use any number of suitable structures capable of executing logical operations according to the embodiments.

As may be appreciated, the method may be implemented in machine-readable logic, such that a set of instructions or code that, when executed, performs the instructions or operations from memory. By way of example, the computer system includes a processor; an input device and memory. The input device is in communication with the processor and is configured to receive input data associated with a subsurface region. The memory is in communication with the processor and the memory has a set of instructions, wherein the set of instructions, when executed, are configured to: obtain subsurface data associated with a subsurface region; perform a process based characterization of non-matrix attributes based on the subsurface data; create a conceptual framework based on the process based characterization; assign non-matrix attributes to the conceptual framework; determine non-matrix effective properties based on the assigned non-matric attributes; and output the non-matrix effective properties.

In yet other configurations, the set of instructions, when executed by the processor, may be configured to: identify one or more production anomalies associated with the subsurface region; update the process-based characterization with static data; update the process-based characterization with dynamic data; integrate the process-based characterizations with seismic data associated with the subsurface region; determine two or more non-matrix types, identify non-matrix types with one of core data and log data associated with the subsurface region, and use the identified non-matrix types to perform the process based characterization of non-matrix attributes; create a subsurface model associated with a subsurface region, wherein the subsurface model comprises a plurality of cells; assign one or more of the non-matrix effective properties to each of the plurality of cells; and/or to simulating fluid flow within the subsurface model based on the non-matrix effective properties.

It should be understood that the preceding is merely a detailed description of specific embodiments of the invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents. It is also contemplated that structures and features embodied in the present examples can be altered, rearranged, substituted, deleted, duplicated, combined, or added to each other. As such, it will be apparent, however, to one skilled in the art, that many modifications and variations to the embodiments described herein are possible. All such modifications and variations are intended to be within the scope of the present invention, as defined by the appended claims.

1. A method for enhancing hydrocarbon operations for a subsurface region comprising:
obtaining subsurface data associated with a subsurface region;
performing a process based characterization of non-matrix attributes based on the subsurface data;
creating a conceptual framework based on the process based characterization;
assigning non-matrix attributes to the conceptual framework;
determining non-matrix effective properties based on the assigned non-matric attributes; and
outputting the non-matrix effective properties.

2. The method of claim 1, further comprising identifying one or more production anomalies associated with the subsurface region.

3. The method of claim 1, wherein the non-matrix attributes are associated with one or more karst in the subsurface region.

4. The method of claim 1, wherein the non-matrix attributes are associated with one or more fractures in the subsurface region.

5. The method of claim 1, further comprising updating the process-based characterization with static data.

6. The method of claim 1, further comprising updating the process-based characterization with dynamic data.

7. The method of claim 1, further comprising integrating the process-based characterizations with seismic data associated with the subsurface region.

8. The method of claim 1, further comprising:
determining two or more non-matrix types;
identifying non-matrix types with one of core data and log data associated with the subsurface region; and
using the identified non-matrix types to perform the process based characterization of non-matrix attributes.

9. The method of claim 1, further comprising:
creating a subsurface model associated with a subsurface region, wherein the subsurface model comprises a plurality of cells;
assigning one or more of the non-matrix effective properties to each of the plurality of cells.

10. The method of claim 1, further comprising simulating fluid flow within the subsurface model based on the non-matrix effective properties.

11. The method of claim 10, further comprising causing a well to be drilled based on the one of the outputted non-matrix effective properties, the simulated fluid flow, and any combination thereof.

12. The method of claim 10, comprising performing a hydrocarbon operation based on the one of the outputted non-matrix effective properties, the simulated fluid flow, and any combination thereof.

13. A system for enhancing hydrocarbon operations associated with a subsurface region, comprising:
a processor;
an input device in communication with the processor and configured to receive input data associated with a subsurface region;
memory in communication with the processor, the memory having a set of instructions, wherein the set of instructions, when executed by the processor, are configured to:
obtain subsurface data associated with a subsurface region;
perform a process based characterization of non-matrix attributes based on the subsurface data;
create a conceptual framework based on the process based characterization;
assign non-matrix attributes to the conceptual framework;
determine non-matrix effective properties based on the assigned non-matric attributes; and
output the non-matrix effective properties.

14. The system of claim 13, wherein the set of instructions, when executed by the processor, are configured to: identify one or more production anomalies associated with the subsurface region.

15. The system of claim 13, wherein the set of instructions, when executed by the processor, are configured to: update the process-based characterization with static data.

16. The system of claim 13, wherein the set of instructions, when executed by the processor, are configured to: update the process-based characterization with dynamic data.

17. The system of claim 13, wherein the set of instructions, when executed by the processor, are configured to integrate the process-based characterizations with seismic data associated with the subsurface region.

18. The system of claim 13, wherein the set of instructions, when executed by the processor, are configured to:
determine two or more non-matrix types;
identify non-matrix types with one of core data and log data associated with the subsurface region; and
use the identified non-matrix types to perform the process based characterization of non-matrix attributes.

19. The system of claim 13, wherein the set of instructions, when executed by the processor, are configured to:
create a subsurface model associated with a subsurface region, wherein the subsurface model comprises a plurality of cells;
assign one or more of the non-matrix effective properties to each of the plurality of cells.

20. The system of claim 13, wherein the set of instructions, when executed by the processor, are configured to simulating fluid flow within the subsurface model based on the non-matrix effective properties.
